(19) United States
(12) Patent Application Publication
(10) Pub. No.: US 2004/0217992 A1
(43) Pub. Date: Nov. 4, 2004

(54) Tablet accessory for personal electronics devices

(76) Inventors: Ray M. Oskulak, San Jose, CA (US); Chris Bradley, Redwood City, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/427,322

(22) Filed: May 1, 2003

(51) Int. Cl. G09G 5/00

(52) U.S. Cl. 345/905

(57) ABSTRACT

A portable display device to increase the screen size of portable display sources such as PDAs (including but not limited to Palms, iPAQs, PDA/Cellular Phones, PocketPCs, etc.), portable phones, DVD players, or any other display device known to persons skilled in the art. The device comprises an interconnect module configured to couple with a specific display source. The interconnect module couples with a display screen housing comprising a display screen. The interconnect module and the display screen housing removably interlock to form a single continuous housing. The portable display device comprises electronic circuitry such that the display output from the display source is displayed on the display screen.

### BACKGROUND OF THE INVENTION

The use of video imaging equipment has become an important aspect of many people's lives. One example of this is the growing use of personal computers. It has been estimated that 60% of American homes have at least one personal computer. The same can be said of televisions and video equipment such as VCRs and DVD players. As these machines become more intertwined in people's lives, there is a natural desire to be divorced of many of the physical transport and use limitations that have traditionally been inherent in them. This desire has lead to the gradual decrease in size of many of these devices in order to increase their portability.

Historically, mobile use of computers and televisions was limited by large VGA monitors and picture tube screens. As liquid crystal displays (LCD) were developed, the overall size and weight of computers and video devices were reduced. Concomitant with the advent of LCD displays was the shift in video and audio recording from analog to digital, thus dramatically reducing the size of storage media. This shift to digital format further facilitated the reduction in size of machines used to play audio and video sources. True portability became a reality with the advent of personal digital assistants (PDAs) and portable DVD players.

Although the popularity of portable devices has increased, there are often times when larger screens are more desirable. For example, a portable DVD player is certainly more convenient when a user is traveling on a plane, or housed in a hotel room. But when the user is at home the smaller screen may become a nuisance. The user's only option is to buy a second larger DVD player to use on a television. Similarly with PDA's, the small size is convenient for portability, but there are times when a larger screen would be desirable, e.g. for reading an electronic book.

Attempts have been made to address some of the above mentioned limitations. In one example, a VGA adapter is connected to a PDA to send its video output to a standard VGA monitor. Similarly, the portable DVD player can be connected to a television in order to view movies on a larger screen. These are not optimal solutions, however, because the user is then dependent on the location of the VGA monitor or television when using the device. This solution eliminates entirely the desired portability of the device.

### SUMMARY OF THE INVENTION

One embodiment of the present invention provides a portable display device configured for attachment to any one of a plurality of different display sources. The display device comprises a display screen enclosed in a display screen housing including an interconnect module docking port. An interconnect module couples with the interconnect module docking port to form a single continuous housing with the display screen housing. The interconnect module comprises an input receptacle configured to couple to a display source. The interconnect module and the display device contain electronic circuitry to transmit the display output from the display source to the display screen such that the display output is displayed on the display screen.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a schematic view of a portable display device in accordance with an embodiment of the present invention;

FIG. 2a is a schematic side view of the portable display device embodiment of FIG. 1;

FIG. 2b is a schematic side view of an another embodiment of the portable display device embodiment of FIG. 1

FIG. 3 is a schematic view of an additional embodiment of a portable display device;

FIG. 4 is a perspective view of the back side of a portable display device embodiment;

FIG. 5 is a perspective view of the front side of a portable display device embodiment;

FIG. 6 is a perspective view of the back side of yet another portable display device embodiment;

FIG. 7 is a perspective side view of another portable display device embodiment;

FIG. 8 is a perspective side view of another portable display device embodiment;

FIG. 9 is a perspective view of yet another portable display device embodiment;

FIG. 10 is a block flow chart representing method steps of one embodiment of the invention; and

FIG. 11 is a second block flow chart representing method steps of one embodiment of the invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

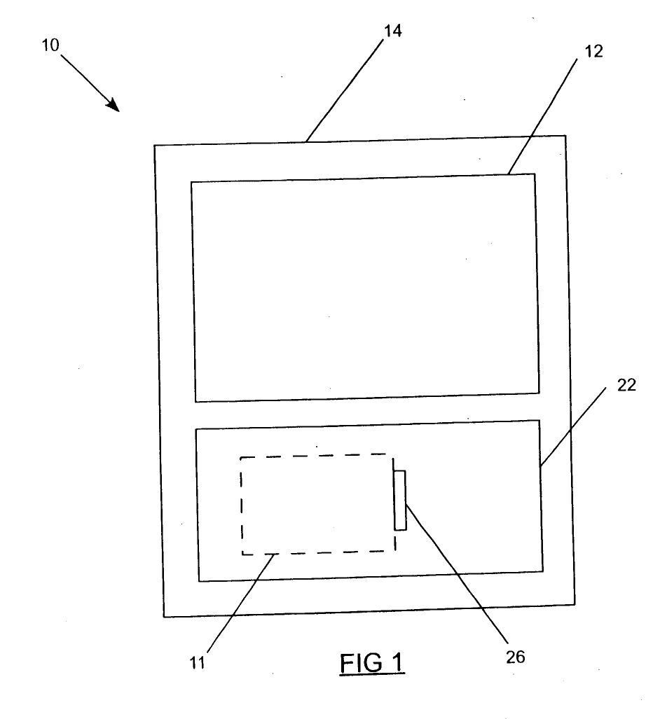

As shown in FIGS. 1 & 2a, an embodiment of the present invention provides a portable display device 10 configured for attachment to any one of a plurality of different display sources 11. Examples of display sources are PDAs (including but not limited to Palms, iPAQs, PDA/Cellular Phones, PocketPCs, etc.), DVD players, or any other display device known to persons skilled in the art. A display screen 12 is substantially enclosed by a display screen housing 14. The display screen may be an LCD screen, touch screen or any other flat display allowing portability of the device. An interconnect module docking port 16 is recessed into the housing 14 and is configured to receive and couple to an interconnect module 18. Display electronic circuitry 20 electronically couples the interconnect module docking port 16 to the display screen 12. The purpose of the display electronic circuitry 20 is to allow the transmission of an electronic signal from the interconnect module docking port 16 to the display screen 12.

An interconnect module 18 is comprised of an interconnect module housing 22 with an output receptacle 24 that is configured to removably interlock with the interconnect module docking port 16. When coupled together the interconnect module housing 22 and the display screen housing 14 form a single continuous housing. There is electronic coupling between the output receptacle 24 and the interconnect module docking port 16. An input receptacle 26 configured to physically and electronically couple to the display source 11 is disposed on the interconnect module 18. Module electronic circuitry 28 electronically couples the input receptacle 26 to the output receptacle 24 to transmit electronic signals.

A power source 30 may be coupled to the display screen 12 to provide power to the display device 10. The power source 30 may also be coupled to the interconnect module 18 via the interconnect module docking port 16 to provide power to the display source 11.

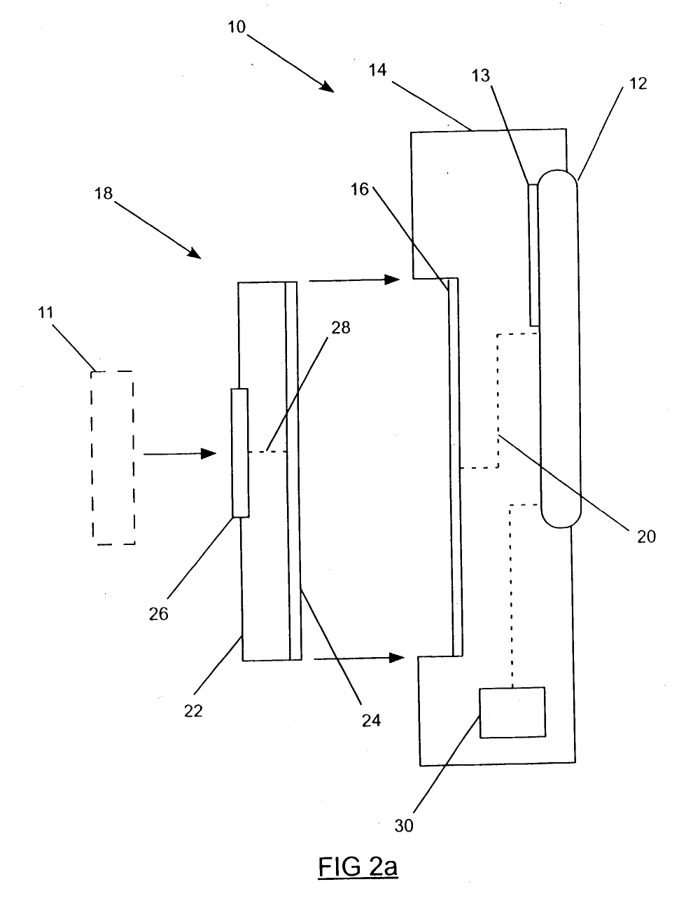

FIG. 2b shows an example embodiment of the present invention in which the interconnect module 19 is integrated with the display source 11. In this embodiment, a display screen 12 is substantially enclosed by a display screen housing 14. The display screen may be an LCD screen, touch screen or any other flat display allowing portability of the device. A docking port 17 is coupled to the housing 14 and is configured to receive and removably couple to a display source 11 via an interconnect module 19. In this embodiment, the interconnect module 19 is coupled to the display source 11. The interconnect module may be integrated with the display source 11 such that it is permanently coupled to the display source 11, or, alternatively, it may be configured to be removably coupled to the display source 11. Display electronic circuitry 20 electronically couples the docking port 17 to the display screen 12. The purpose of the display electronic circuitry 20 is to allow the transmission of an electronic signal from the docking port 17 to the display screen 12.

A power source 30 may be coupled to the display screen 12 to provide power to the display device 10. The power source 30 may also be coupled to the interconnect module 19 via the docking port 17 to provide power to the display source 11.

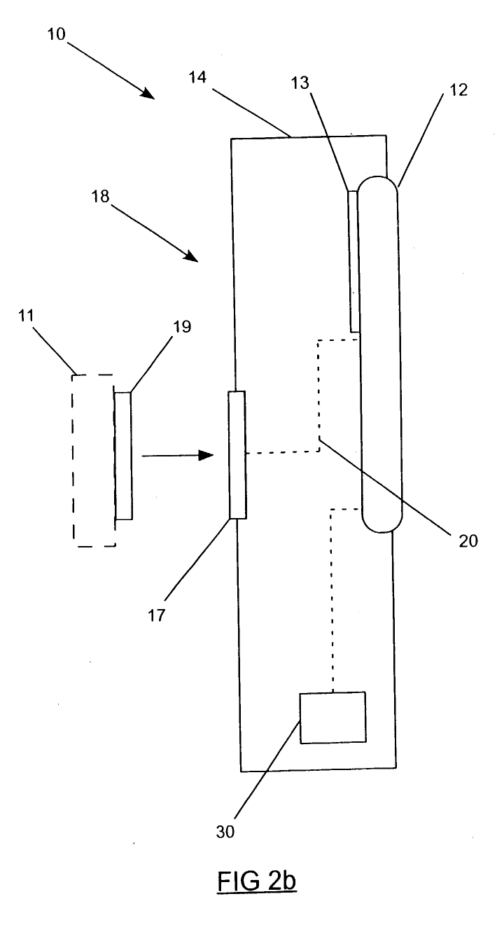

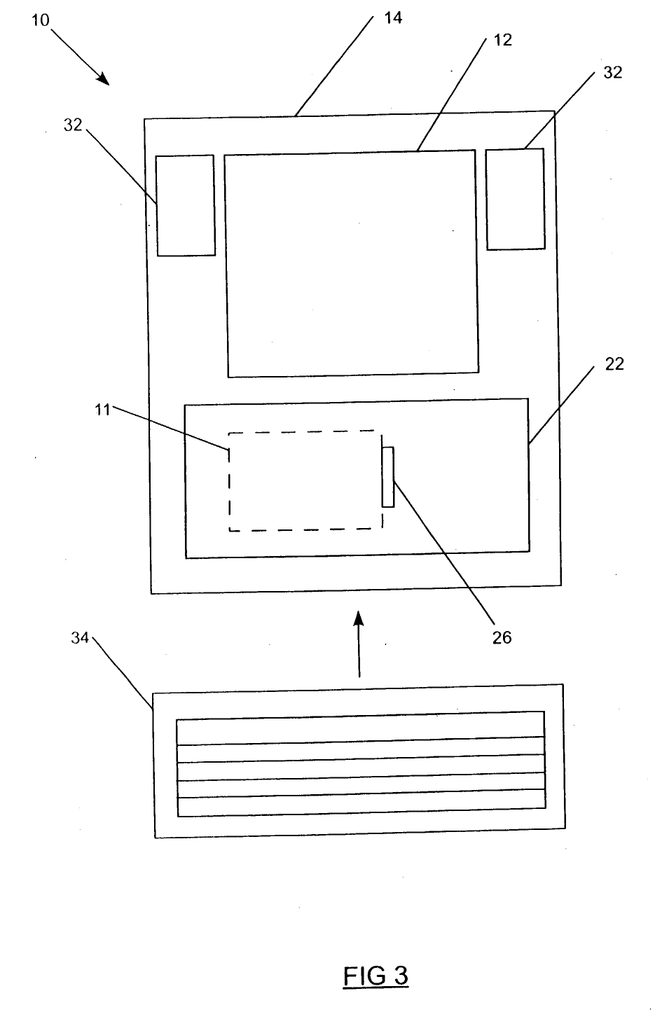

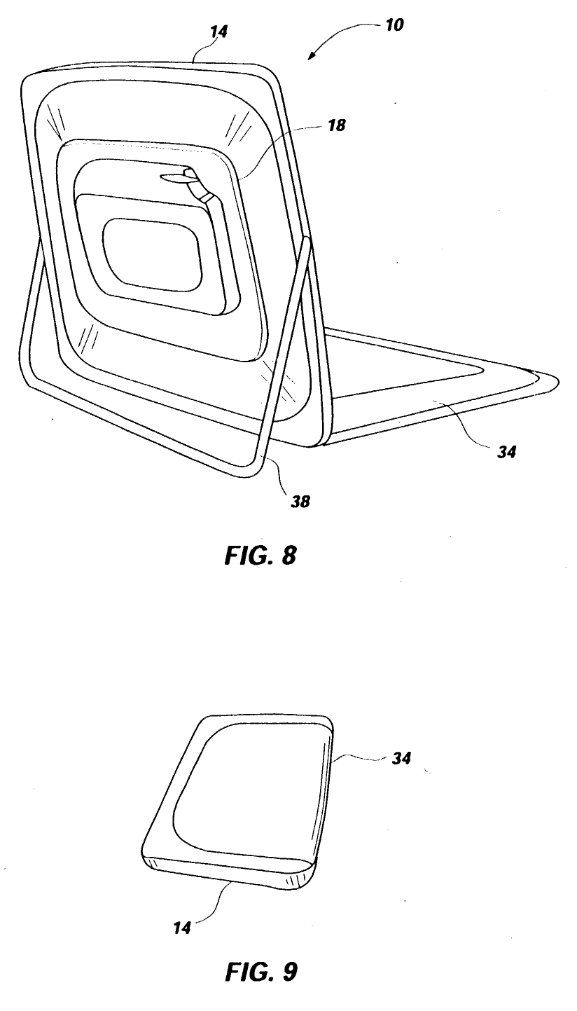

As shown in FIG. 3, additional embodiments might include a removable keyboard 34 to allow interaction with the display source 11. An additional view of the removable keyboard 34 can be seen in FIG. 8. The keyboard 34 may be designed to fold across the across the surface of the display screen 12 to protect the display screen 12 when not in use (FIG. 9).

Additionally, at least one speaker 32 (FIG. 3) may be coupled to the display screen housing 14 to receive and play audio signals accompanying a display signal. The speaker 32 may be a traditional cone speaker, a flat panel speaker (see FIGS. 2, 13), or any other speaker device known to one skilled in the art. A flat panel speaker 13 may be integrated with the display screen 12.

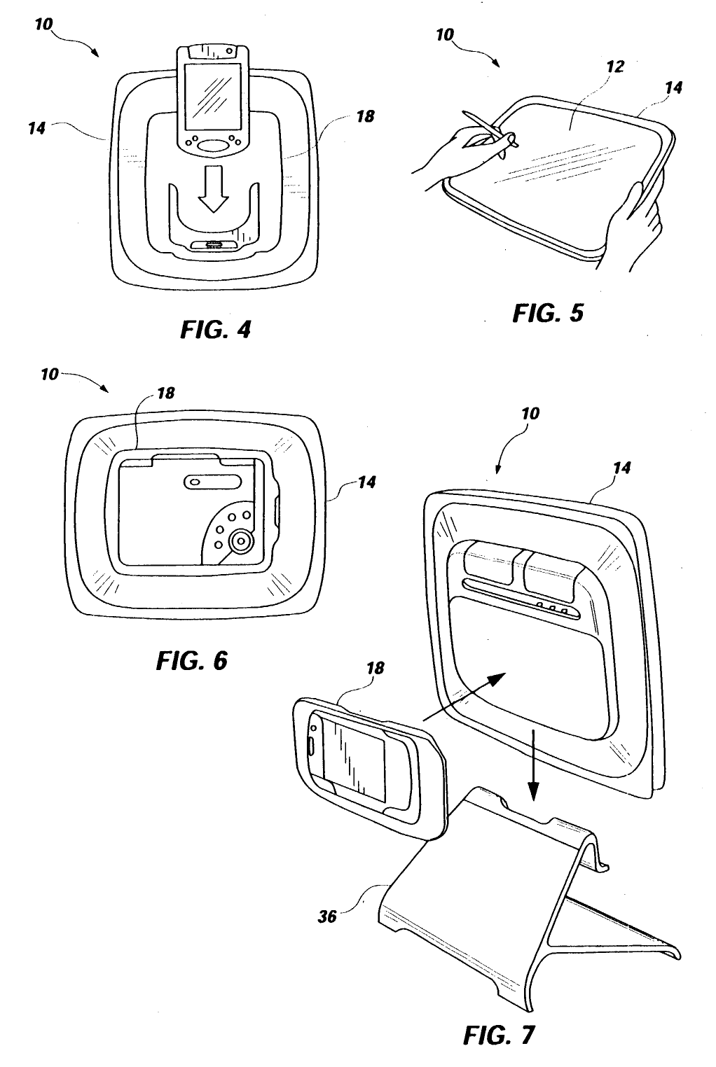

Referring to FIGS. 2a, 3-6, in a typical use situation, a user would couple a display source 11 to the input receptacle 26 of an interconnect module 18. The interconnect module is then coupled to the display screen housing 14. The purpose of the interconnect module is to allow various different display sources 11 to be coupled to the same display device 10. For example, the electronic output from a PDA is transmitted to the input receptacle 26, through the module electronic circuitry 28 to the output receptacle 24 of the interconnect module 18. Due to the nature of the electronic coupling interaction between the output receptacle 24 and the interconnect module docking port 16, the output from the PDA is then transmitted to the display screen 12 via the display electronic circuitry 20. Thus the output from the PDA is displayed on the larger display screen 12 of the display device 10.

As another example, a portable DVD player is coupled to the input receptacle 26 of an interconnect module 18 that has been configured to accept the portable DVD player. By coupling the interconnect module 18 to the interconnect module docking port 16 of the-display device 10, display output may be played on larger display screen than what is provided with the portable DVD player.

As shown in FIG. 7, the display screen housing 14 may be coupled to a stand 36 configured to hold the portable display device 10 in an upright position, thus eliminating the need for the user to hold the portable display device 10 in a position for viewing. As shown in FIG. 8, another means for supporting the portable display device 10 in an upright position could be accomplished by a kick stand 38 coupled to the display screen housing 14. The kick stand 38 would extend from opposing side locations on the display screen housing 14, thus supporting the portable display device 10.

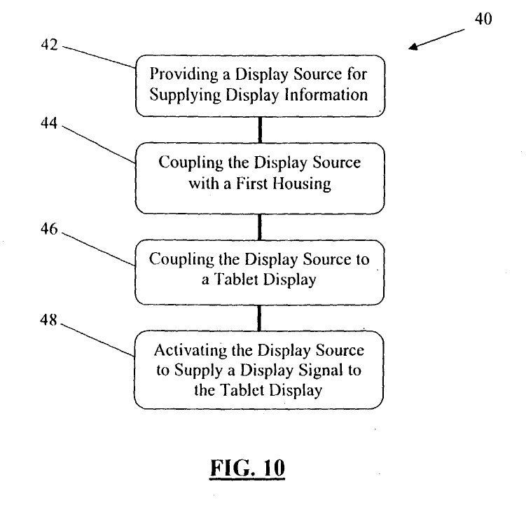

As shown in FIG. 10, the invention may also be embodied as a method 40 for displaying data on a tablet display using multiple display sources. In the first step 42 of the method a display source is provided for supplying display information. In the second step 44, the display source is coupled with a first housing. This first housing is configured to couple with the specific display source being utilized. In the third step 46, the first housing is coupled with a tablet display, such that the first housing and the tablet display housing form a substantial enclosure representing an integrated housing. In the fourth step 48 the user activates the display source to supply a display signal to the tablet display.

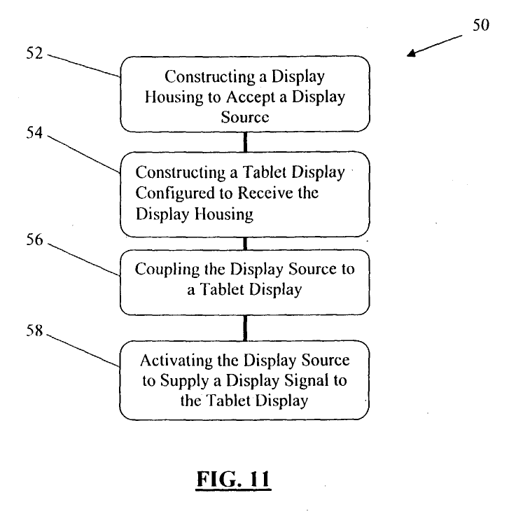

As shown in FIG. 11, the invention may also be embodied as a method 50 for manufacturing a tablet display for using multiple display sources. In the first step 52 of the method, a display housing is constructed such that it can accept a display source. This display housing is configured to couple with a specific display source. In the second step 54, a tablet display is constructed and configured to receive the display housing. In the third step 56, electronic circuitry is configured within the display housing such that a display signal from the display source can be transmitted to the tablet display. In the fourth step 58, electronic circuitry is configured within the tablet display such that a display signal received from the display housing is displayed on the tablet display.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth in the claims.

What is claimed is:

1. A portable display device configured for attachment to any one of a plurality of different display sources, comprising:
a) a display screen having a display screen housing which substantially encloses the display screen, said housing further comprising an interconnect module docking port;
b) display electronic circuitry configured to electronically couple the interconnect module docking port to the display screen; and
c) an interconnect module having:
1) an interconnect module housing with an output receptacle configured to couple with the interconnect module docking port such that the display screen and the interconnect module removeably interlock to form a single continuous housing;
2) an input receptacle which couples with the display source;
3) module electronic circuitry to electronically couple the input receptacle to the output receptacle, wherein display output from the display source is electronically transmitted via the module electronic circuitry to the interconnect module docking port.

2. A portable display device as in claim 1, wherein a power source coupled to the display screen to provide power to the device.

3. A portable display device as in claim 2, wherein the power source is coupled to the interconnect module to provide power to the display source.

4. A portable display device as in claim 1, wherein the display screen is an LCD screen.

5. A portable display device as in claim 1, wherein the display screen is a touch screen, allowing the user to interact with the display source by touching the display screen.

6. A portable display device as in claim 1, further comprising a keyboard removeably coupled to the display screen and electronically coupled to the interconnect module to allow interaction with the display source.

7. A portable display device as in claim 6, wherein the keyboard can fold across the surface of the display screen to protect the display screen when not in use.

8. A portable display device as in claim 1, further comprising a speaker electronically coupled to the display screen housing to receive and play an audio signal accompanying a display signal.

9. A portable display device as in claim 8, wherein the speaker is a flat panel speaker that is integrated with the display screen.

10. A portable display device as in claim 1, further comprising a stand configured to removably couple with the portable display device, such that the portable display device will stand upright.

11. A portable display device as in claim 1, further comprising a kick stand coupled to opposing side locations of the portable display device, where in the kick stand extends from the portable display device to support the portable display device in an upright position.

12. A method for displaying data on a tablet display using multiple display sources, comprising the steps of:
a) providing a display source for supplying display information;
b) coupling the display source with a first housing;
c) coupling a tablet display including a display housing to the first housing to form a substantial enclosure representing an integrated housing; and
d) activating the display source to supply a display signal to the tablet display.

13. A method for manufacturing a tablet display for using multiple display sources, comprising the steps of:
a) constructing a display housing to accept a display source;
b) constructing a tablet display configured to receive the display housing;
c) configuring electronic circuitry within the display housing such that a display signal from the display source can be transmitted to the tablet display; and
d) configuring electronic circuitry within the tablet display such that a display signal may be received from the display housing and displayed on the tablet display.

14. A portable display device configured for attachment to any one of a plurality of different display sources, comprising:
a) a display screen having a display screen housing which substantially encloses the display screen;
b) a docking port coupled to the display screen housing;
c) an interconnect module configured for coupling to the display source, the interconnect module being configured to removably couple to the docking port; and
d) display electronic circuitry configured to electronically couple the docking port to the display screen, wherein display output from the display source is received by the docking port and electronically transmitted via the display electronic circuitry to the display screen.

15. A portable display device as in claim 14, wherein a power source coupled to the display screen to provide power to the device.

16. A portable display device as in claim 14, further comprising a keyboard removeably coupled to the display screen and electronically coupled to the interconnect module to allow interaction with the display source.

17. A portable display device as in claim 14, wherein the display screen is an LCD screen.

18. A portable display device as in claim 14, wherein the display screen is a touch screen, allowing the user to interact with the display source by touching the display screen.

19. A portable display device as in claim 14, further comprising a speaker electronically coupled to the display screen housing to receive and play an audio signal accompanying a display signal.

20. A portable display device as in claim 19, wherein the speaker is a flat panel speaker that is integrated with the display screen.
